(19) United States
(12) Patent Application Publication
(10) Pub. No.: US 2026/0080632 A1
(43) Pub. Date: Mar. 19, 2026

(54) COLLABORATIVE 3D CONTENT CREATION FOR AUGMENTED REALITY

(71) Applicant: Snap Inc., Santa Monica, CA (US)

(72) Inventor: Mitchell Kuppersmith, Los Angeles, CA (US)

(21) Appl. No.: 18/927,143

(22) Filed: Oct. 25, 2024

Related U.S. Application Data
(60) Provisional application No. 63/695,244, filed on Sep. 16, 2024.

(51) Int. Cl. G06T 19/00; G06F 40/205; G06F 40/279; G06F 40/40; G06T 7/11; G06T 17/20; G06T 19/20

(52) U.S. Cl. CPC G06T 19/006; G06F 40/205; G06F 40/279; G06F 40/40; G06T 7/11; G06T 17/20; G06T 19/20; G06T 2210/36; G06T 2219/024; G06T 2219/2016

(57) ABSTRACT

A system and method for generating and displaying three-dimensional (3D) content in an augmented reality (AR) environment based on voice input from multiple users. The system includes a server that receives text converted from speech detected at an AR device, generates prompts for language and image generation models, and processes the resulting 2D representation into a 3D model. The 3D model is refined and transmitted to the AR device for presentation. The system incorporates safety checks, supports multi-user interactions, and enables real-time synchronization of 3D content across multiple AR devices in a shared space. This invention integrates voice commands, advanced AI models, and multi-user AR interactions to create an immersive and collaborative 3D content generation experience.

### RELATED APPLICATIONS

This application claims priority to U.S. Provisional Patent Application No. 63/695,244, filed on Sep. 16, 2024, titled “Collaborative 3D Content Creation for Augmented Reality,” the entirety of which is incorporated herein by reference for all purposes.

### TECHNICAL FIELD

The present disclosure describes innovative techniques relating generally to augmented reality (AR) technologies and generative artificial intelligence (AI), and more particularly to systems and methods for creating and interacting with three-dimensional (3D) content in shared AR environments. Specifically, the invention pertains to a voice-activated, multi-user 3D generative AI experience that enables users to collaboratively create, view, and manipulate 3D models in real-time using AR devices such as smart glasses.

### BACKGROUND

The creation of content for augmented reality (AR) environments presents significant challenges, particularly in keeping pace with the rapid advancements in hardware capabilities. Traditional software development and content creation processes often struggle to match the speed at which AR devices and technologies are evolving.

Creating high-quality, immersive content for AR can be an intricate and time-consuming process. It typically involves multiple stages, including 3D modeling, texturing, animation, and integration with AR platforms. Each of these stages requires specialized skills and tools, making the content creation pipeline complex and resource-intensive.

### BRIEF DESCRIPTION OF THE DRAWINGS

In the drawings, which are not necessarily drawn to scale, like numerals may describe similar components in different views. To easily identify the discussion of any particular element or operation, the most significant digit or digits in a reference number refer to the figure number in which that element is first introduced. Some non-limiting examples are illustrated in the figures of the accompanying drawings in which:

FIG. 1 is a diagrammatic representation of a networked environment in which innovative techniques, consistent with those described herein, may be deployed, according to some examples.

FIG. 2 is a block diagram depicting various components of an interaction client and servers in accordance with some examples.

FIG. 3 is an illustration showing an example augmented reality (AR) scene generated by the system, including a user wearing an AR device and a virtual three-dimensional (3D) object created based on the user's voice command.

FIG. 4 is a block diagram illustrating components of an AR device and a server system for implementing the collaborative 3D content creation system, in accordance with some examples.

FIG. 5 is a flowchart depicting a method performed by an AR device for generating and displaying a 3D content item, consistent with some examples.

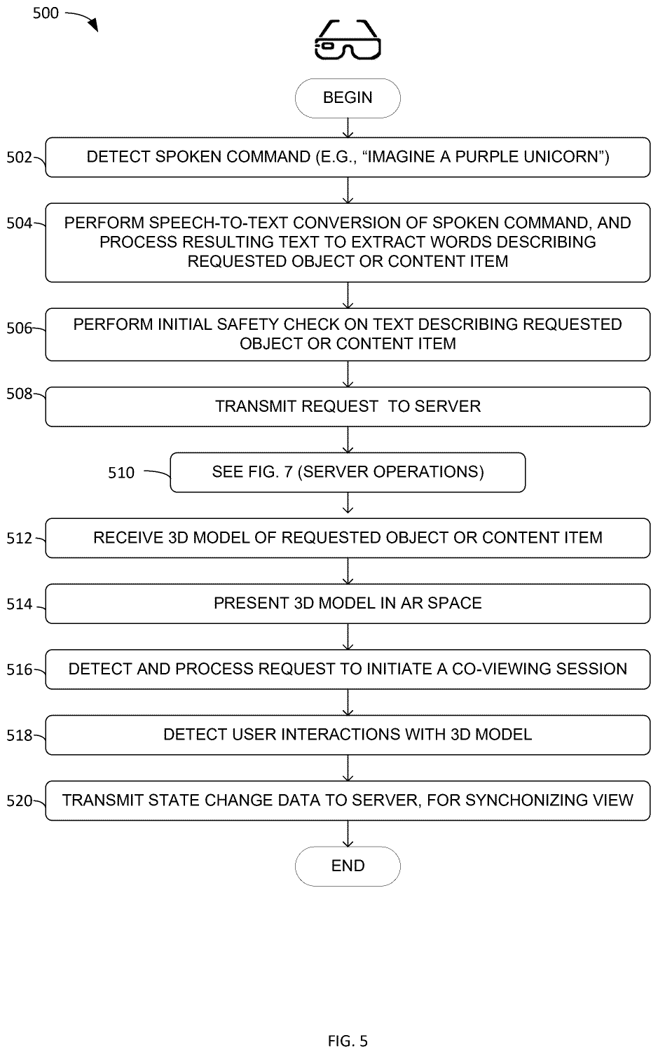

FIG. 6 is a flowchart illustrating a method performed by a server for generating a three-dimensional content item based on a user request, in accordance with some examples.

FIG. 7 is a block diagram showing the components of a head-wearable apparatus, including various sensors, processors, and communication interfaces, as well as its interaction with a mobile device and server system, consistent with some examples.

FIG. 8 is a block diagram illustrating the hardware architecture of a computing device, including processors, memory, storage, and I/O components, consistent with some examples.

FIG. 9 is a block diagram depicting the software architecture of a computing device, showing various applications, frameworks, and system components, consistent with some examples.

### DETAILED DESCRIPTION

Described herein are techniques for creating and interacting with three-dimensional (3D) content in shared augmented reality (AR) environments using voice-activated generative artificial intelligence (AI). The presented techniques employ a novel approach to 3D content generation by implementing a multi-step pipeline that combines voice recognition, natural language processing, image generation, and 3D model creation. By utilizing multiple AI models and intelligent processing techniques, the system addresses common challenges in AR content creation such as real-time generation, multi-user collaboration, and seamless integration with physical environments. The methods described herein provide a more intuitive and collaborative user experience in AR applications by enabling users to generate and manipulate 3D content through voice commands, thereby improving the overall creativity and engagement in shared AR spaces. In the following description, for purposes of explanation, numerous specific details are set forth to provide a thorough understanding of the various aspects of different embodiments of the present solution. It will be evident, however, to one skilled in the art, that the solution may be practiced with varying combinations of the several features set forth, and in some cases without all of the specific features and details set forth herein.

The creation of compelling and interactive content for AR environments presents significant technical challenges that have long hindered the widespread adoption and utilization of AR technologies. Traditional methods of content creation for AR are often time-consuming, requiring specialized skills in 3D modeling, animation, and programming. This complexity creates a bottleneck in the content creation pipeline, limiting the amount and variety of AR experiences available to users. Moreover, the static nature of pre-created content fails to fully leverage the dynamic and interactive potential of AR environments, where users expect real-time responsiveness and personalization.

The specialized skills required for AR content creation typically demand a working knowledge of several different software environments and applications, further compounding the complexity of the process. Content creators often need proficiency in 3D modeling software such as Maya, Blender, or 3ds Max for creating detailed 3D assets. Additionally, they must be familiar with texturing tools like Substance Painter or Adobe Photoshop to add realistic surface details to these models. Animation software such as Adobe Animate or Autodesk MotionBuilder is often necessary for bringing characters and objects to life within the AR space.

Furthermore, developers need expertise in game engines like Unity or Unreal Engine, which are commonly used for integrating 3D assets into AR environments and handling real-time rendering and interactions. Programming skills in languages such as C #, C++, or JavaScript are essential for implementing AR functionality and creating interactive elements. Knowledge of AR development frameworks like ARKit, ARCore, or Vuforia is also crucial for leveraging device-specific AR capabilities.

In addition to these core tools, content creators must often navigate specialized software for tasks such as photogrammetry for creating 3D models from real-world objects, motion capture for realistic character animations, and sound design tools for creating immersive audio experiences. The need to seamlessly integrate outputs from these diverse software environments adds layers of complexity to the AR content creation process, requiring not only individual expertise in each tool but also a deep understanding of how to effectively combine and optimize their outputs for AR platforms.

This multifaceted skill set requirement creates a high barrier to entry for AR content creation, limiting the pool of qualified creators and consequently restricting the diversity and volume of AR experiences available to users. The complexity of juggling multiple software environments also extends development timelines and increases the potential for technical issues, further impeding the rapid iteration and deployment of AR content that is often necessary to meet user expectations for fresh and engaging experiences.

Another critical challenge in AR content creation is the need for real-time generation and rendering of 3D objects that seamlessly integrate with the physical environment. Existing solutions often struggle to produce high-quality 3D content on-demand, particularly in multi-user scenarios where multiple participants may need to interact with the same virtual objects simultaneously. This limitation restricts the spontaneity and collaborative potential of AR experiences, reducing their effectiveness in social and professional settings.

Furthermore, the user interface for creating and manipulating AR content has traditionally been complex, requiring users to navigate intricate menus or learn specific gestures. This complexity creates a barrier to entry for many users, limiting the accessibility and widespread adoption of AR content creation tools. The need for intuitive, natural interaction methods that allow users to effortlessly bring their ideas to life in AR environments remains a significant challenge in the field.

To address these challenges, a novel solution has been developed that combines voice-activated commands with advanced AI models to enable real-time, collaborative 3D content creation in AR environments. This solution leverages a multi-step data processing pipeline that begins with voice input capture and transcription, followed by prompt refinement using natural language processing. The refined prompt is then used to generate a 2D image, which is subsequently transformed into a 3D model through a series of AI-powered processes. The resulting 3D model can be instantly displayed in the AR environment, where multiple users can view, interact with, and modify it in real-time.

This approach significantly streamlines the content creation process for AR, allowing users to generate complex 3D objects simply by describing them verbally. By integrating voice commands with generative AI, the solution removes the need for specialized 3D modeling skills, making AR content creation accessible to a wider audience. The real-time nature of the generation process enables spontaneous creativity and rapid iteration, fostering a more dynamic and engaging AR experience. Other aspects and advantages of the innovative techniques will be readily apparent from reading the detailed descriptions of the several figures that follows.

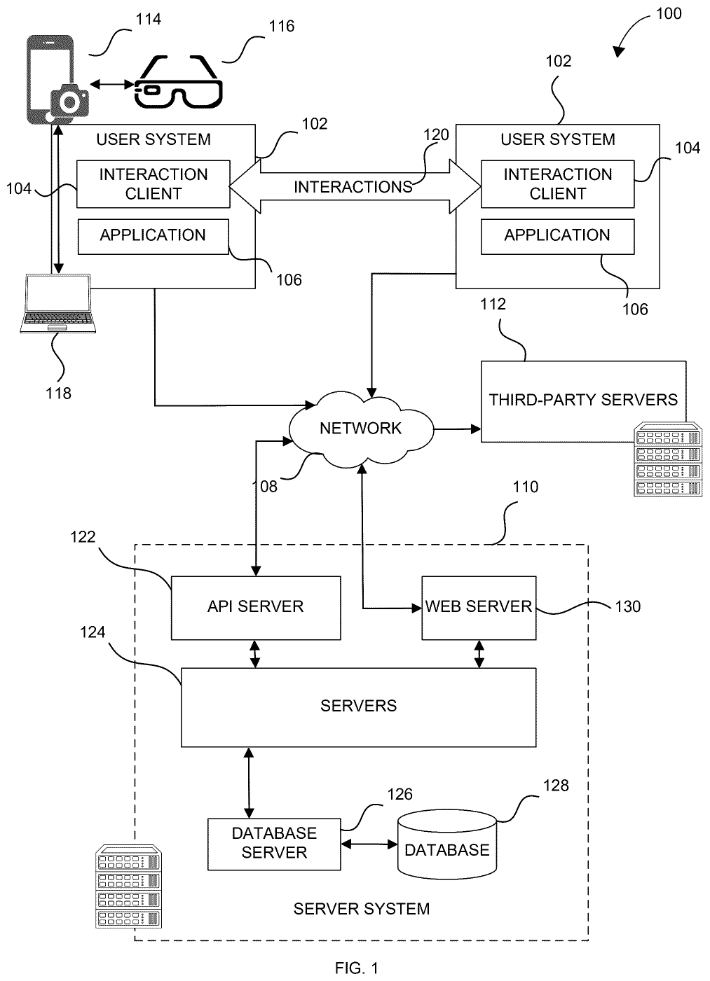

FIG. 1 is a block diagram showing an example digital interaction system 100 for facilitating collaborative 3D content creation and viewing in an AR environment. The digital interaction system 100 includes multiple user systems 102, each of which hosts an interaction client 104 capable of generating and displaying 3D content items based on voice input. Each interaction client 104 is communicatively coupled, via one or more communication networks including a network 108 (e.g., the Internet), to other instances of the interaction client 104, a server system 110, and third-party servers 112.

Each user system 102 may include multiple user devices, such as a mobile device 114 and a head-wearable apparatus 116 (e.g., AR glasses). The head-wearable apparatus 116 includes sensors and cameras capable of capturing environmental data, detecting objects in the user's surroundings, and receiving voice commands for 3D content generation.

An interaction client 104 interacts with other interaction clients 104 and with the server system 110 via the network 108. The data exchanged between the interaction clients 104 (e.g., interactions 120) and between the interaction clients 104 and the server system 110 includes voice input data, text prompts, 2D representations, 3D models, and state change data for synchronizing views in co-viewing sessions.

The server system 110 provides server-side functionality for 3D content generation via the network 108 to the interaction clients 104. This includes processing text prompts through generative language models, generating 2D representations using image generation models, and converting 2D representations into refined 3D models using a specialized content creation, data processing pipeline.

The server system 110 supports various services and operations that are provided to the interaction clients 104. Such operations include receiving text obtained from speech-to-text conversion, generating prompts for language and image generation models, processing 2D representations into 3D models, and managing synchronization for co-viewing sessions.

Turning now specifically to the server system 110, an Application Programming Interface (API) server 122 is coupled to and provides programmatic interfaces to servers 124, making the functions of the servers 124 accessible to interaction clients 104. The servers 124 are communicatively coupled to a database server 126, facilitating access to a database 128 that stores data associated with 3D content generation and co-viewing sessions. Similarly, a web server 130 is coupled to the servers 124 and provides web-based interfaces to the servers 124.

The API server 122 receives and transmits data between the servers 124 and the user systems 102. Specifically, the API server 122 provides interfaces for functions such as receiving text prompts, processing prompts through language and image generation models, converting 2D representations to 3D models, refining 3D models, and managing state changes for co-viewing sessions.

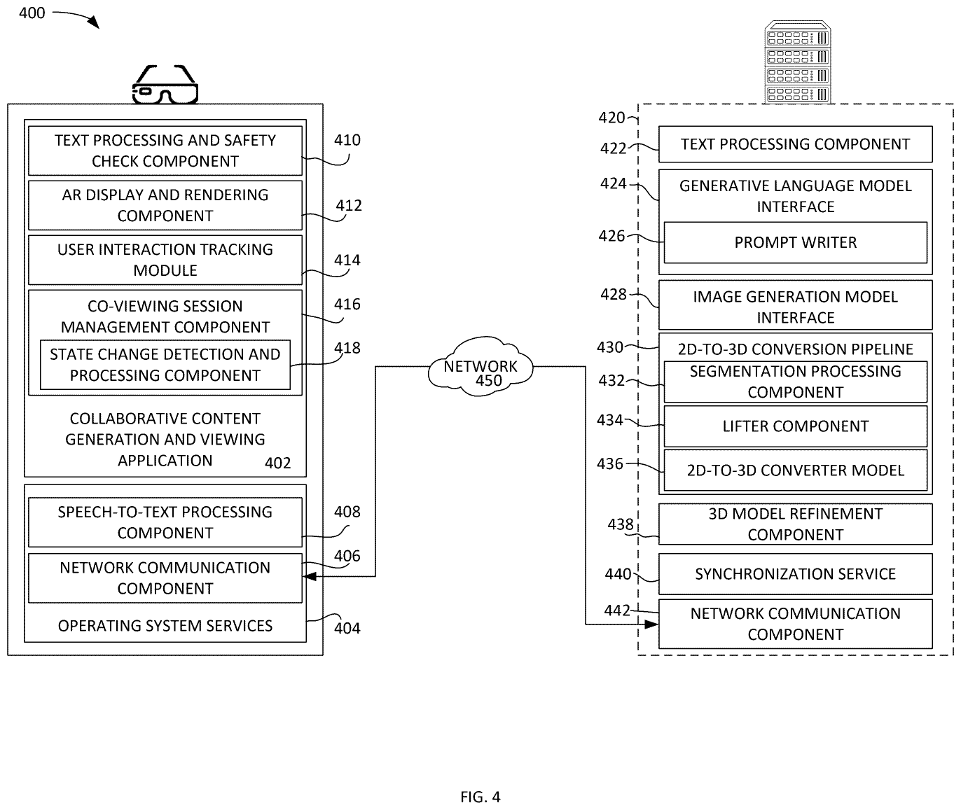

The servers 124 host multiple systems and subsystems, including components for text processing, generative language model interfacing, image generation, 2D-to-3D conversion, 3D model refinement, and synchronization services, as described in more detail with reference to FIG. 4.

### Linked Applications

Consistent with some examples, the interaction client 104 provides a user interface that enables access to features and functions of external resources, such as linked applications 106 or applets, which provide for the 3D content generation and augmented reality (AR) experience. In this context, “external” refers to resources that are separate from but integrated with the interaction client 104. These external resources may be provided by third parties or by the creator of the interaction client 104 and incorporate advanced AI models and computer vision algorithms essential for 3D content generation and AR rendering.

The external resource may be a full-scale application installed on the user system 102, or a lightweight version (e.g., an “applet”) hosted either locally or remotely, such as on third-party servers 112. These lightweight versions include a subset of features specifically tailored for 3D content generation and AR visualization, implemented using markup-language documents, scripting languages, and style sheets.

When a user selects an option to launch or access an external resource, the interaction client 104 determines whether it is a web-based resource or a locally installed application 106. For locally installed applications, the interaction client 104 instructs the user system 102 to execute the corresponding code. For web-based resources, the interaction client 104 communicates with third-party servers 112 to obtain and process the necessary markup-language documents, presenting the resource within its user interface.

The interaction client 104 can notify users of activity in external resources related to 3D content generation or collaborative AR experiences. For instance, it can provide notifications about recent 3D models created by friends or invite users to join active co-viewing sessions. Users can share generated 3D content or AR scenes through interactive chat cards, allowing other users to view or manipulate the shared content within the AR environment.

The interaction client 104 presents a list of available external resources specialized in 3D content generation and AR experiences. This list can be context-sensitive, with icons representing different applications or applets varying based on the user's current activity or location within the AR environment.

### System Architecture

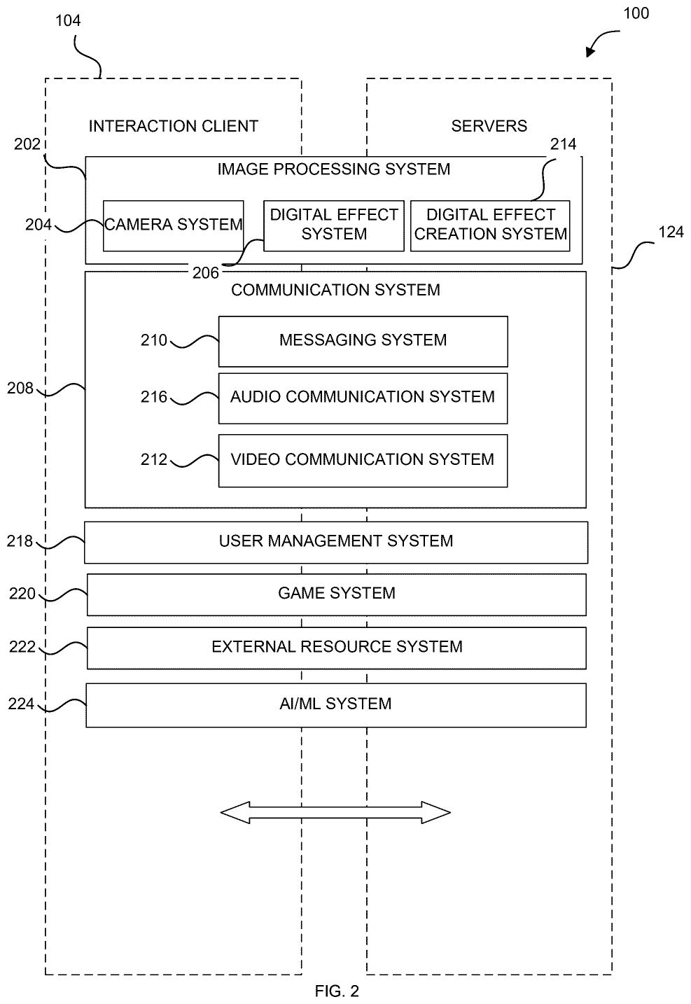

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124.

The image processing system 202 provides various functions that enable a user to capture and modify media content associated with a message. The image processing system 202 includes functionality for analyzing environmental data captured by the AR device's sensors to determine appropriate spatial positions for displaying 3D visual representations of requested content items in the AR environment. This system processes images of the user's surroundings to detect objects and features, which are then used to intelligently position the generated 3D content in relation to the real-world environment. By leveraging computer vision algorithms, the image processing system 202 ensures that the placement of requested 3D objects is contextually relevant and visually coherent within the user's AR view.

A camera system 204 includes control software that interacts with and controls camera hardware of the user system 102 to modify real-time images captured and displayed via the interaction client 104. The camera system 204 is used to capture images of the user's surroundings, which are then analyzed using computer vision algorithms to detect objects and determine the user's presence in specific real-world locations associated with chat threads.

The digital effect system 206 provides functions related to the generation and publishing of digital effects (e.g., media overlays) for images captured in real-time by cameras of the user system 102 or retrieved from memory of the user system 102. Consistent with some embodiments, the digital effect system 206 is responsible for generating and rendering 3D visual representations of chat messages in the AR environment, taking into account the spatial positioning determined based on environmental data and detected objects.

A communication system 208 is responsible for enabling and processing multiple forms of communication and interaction within the digital interaction system 100 and includes a messaging system 210, an audio communication system 216, and a video communication system 212. The communication system 208 manages the association of chat messages and threads with specific real-world destinations, and controls the presentation of messages to users based on their physical location. The messaging system 210 includes functionality for storing chat messages in association with specified real-world destinations, retrieving them when users enter the corresponding physical locations, and managing the temporal attributes of messages within chat threads to enable depth-based positioning in the AR environment.

A user management system 218 is operationally responsible for the management of user data and profiles, and maintains entity information regarding users and relationships between users of the digital interaction system 100. The user management system 218 tracks user locations and manages the detection of users entering specific physical locations corresponding to chat thread destinations.

An external resource system 226 provides an interface for the interaction client 104 to communicate with remote servers (e.g., third-party servers 112) to launch or access external resources, i.e., applications or applets. This system enables the integration of advanced AI models and computer vision algorithms essential for 3D content generation and AR rendering.

An artificial intelligence and machine learning system 230 provides a variety of services to different subsystems within the digital interaction system 100. The artificial intelligence and machine learning system 230 includes generative language models used for analyzing chat message content, determining relevant topics, and matching them with detected objects in the user's environment to position chat messages appropriately in 3D space.

The artificial intelligence and machine learning system 230 also interfaces with the external resource system 226 to leverage externally hosted large language models and other generative AI services. This integration enables advanced natural language processing capabilities for analyzing chat messages and determining relevant topics. The AI/ML system 230 includes a prompt processing component that receives incoming chat messages and generates tailored prompts for the external language models.

These components work together to enable the generation and manipulation of 3D content in an augmented reality environment based on voice input, leveraging advanced AI models for natural language processing, image generation, and 3D model creation. The system supports collaborative experiences by allowing multiple users to interact with the same 3D content in a shared AR space, with real-time synchronization of user interactions across devices.

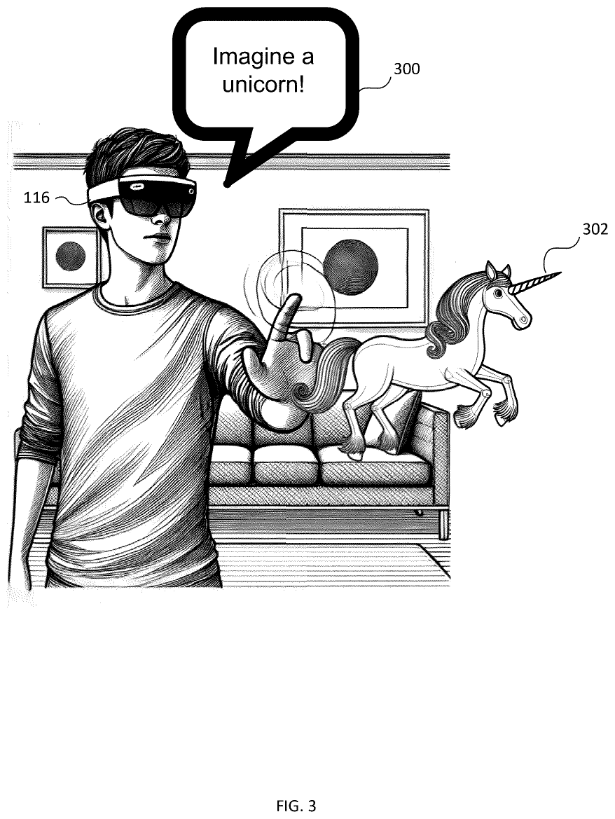

FIG. 3 illustrates an example of a user interacting with an AR device 116 and system to generate and view a 3D content item 302. The figure shows a user wearing an AR device 116, such as AR glasses or a head-mounted display, who has spoken a command 300 “Imagine a unicorn!” to invoke the generation of a 3D object 302, in this case a unicorn, that is being presented via the display of the AR device in 3D space.

In some examples, the system may rely on a trigger word, such as “Imagine,” to initiate the content generation process. However, the trigger word may vary depending on the implementation. Alternatively, in some examples, a generative language model may be used to process commands and determine which ones are requests directed to the content generation application or service. This approach allows for more natural language interactions and flexibility in how users can initiate 3D content creation.

The illustration shown in FIG. 3 presents a second-person view, illustrating what an observer might see when looking at the user wearing the AR device 116. The unicorn 302 is shown to convey what the user might be seeing through their AR display. Alternatively, this view could represent what a second user would see if they were using another AR device and engaged in a co-viewing session with the user wearing AR device 116, highlighting the collaborative nature of the system.

It is important to note that while FIG. 3 provides a static representation of the 3D content generation process, in an actual implementation, there may be a small, but non-trivial amount of time between the user issuing the voice command and the presentation of the final 3D model representing the requested object. During this interval, the system performs several complex operations, including speech-to-text conversion, prompt generation, safety checks, image generation, and 3D model creation and refinement.

To bridge this temporal gap and provide feedback to the user, the AR device may present one or more intermediate graphics or animations while the system is processing the command. These visual cues serve to indicate that the system is actively working on generating the requested content. Such intermediate feedback could take various forms, such as a loading spinner, a pulsing light, or a more elaborate animation thematically related to the content being created.

For example, after the user speaks the command “Imagine a unicorn!”, the AR device 116 might display a shimmering outline or a swirling mist in the area where the 3D model will eventually appear. This intermediate visual feedback not only informs the user that their command has been received and is being processed but also helps maintain user engagement during the generation process.

As the system progresses through its various stages of content creation, the intermediate graphics could evolve or change to reflect the current stage of processing. For instance, the display might transition from a generic “processing” animation to a more specific “rendering” animation as the system moves from 2D image generation to 3D model conversion.

Ultimately, when the final 3D model is ready, it seamlessly replaces these intermediate graphics, appearing in the user's field of view as if it has materialized out of thin air. This transition from voice command to intermediate feedback to final 3D model presentation creates a more dynamic and interactive user experience, despite the underlying complexity and time required for the content generation process. The user can then interact with the 3D model, potentially manipulating it through gestures or voice commands. These interactions can be synchronized with other users in co-viewing sessions, allowing for collaborative experiences in shared AR spaces.

To establish a co-viewing session with another user wearing an AR device, the system leverages the co-viewing session management component 416. A user can initiate a co-viewing session through a voice command or gesture, which is detected and processed by the co-viewing session management component. Once initiated, this component creates a shared AR environment where the 3D content is synchronized between users.

In this shared space, each user would see the same 3D object, but from their own perspective relative to the object's position in the shared AR environment. For example, if one user is viewing the unicorn from the front, and another user is viewing it from the side, they would each see the appropriate view of the unicorn based on their physical position in the real world.

Users can manipulate the shared 3D object using gestures, which are detected by the user interaction tracking module 414. When a user interacts with the object, the state change detection and processing component 418 identifies these changes and prepares the data for synchronization. This data is then transmitted to the server's synchronization service 440, which processes the information and ensures all connected AR devices in the co-viewing session receive updates in real-time. This allows all users to see the same manipulations of the 3D object simultaneously, creating a truly collaborative AR experience.

FIG. 3 thus encapsulates several aspects of the innovative system: voice-activated 3D content generation in AR, real-time processing and rendering of complex 3D models, and the potential for multi-user interactions with the generated content. This visual representation helps to illustrate the seamless and intuitive nature of the user experience, where complex technological processes are abstracted away, allowing users to bring their imaginations to life in a shared, augmented reality environment.

FIG. 4 illustrates a block diagram of components of an a AR device and a server system for implementing the collaborative 3D content creation system, in accordance with some examples. The left side of FIG. 4 depicts the AR device 400, which includes an operating system with various services 404. Among these services is a speech-to-text processing component 408, responsible for transforming audible spoken instructions into text. The AR device also includes a network communication component 406 to support data interchange over a network with a server and potentially other devices.

In some examples, the innovative functionality set forth herein may be provided by a standalone application—the collaborative content generation and viewing application 402. This application 402 receives an audible spoken instruction or command, which is converted to text and then processed by the text processing and safety check component 410. The safety check involves parsing the text for predetermined keywords associated with inappropriate content, ensuring that the generated content adheres to content guidelines.

The AR display and rendering component 412 is responsible for presenting the generated 3D content in the AR environment. It works in conjunction with the image processing system to accurately display the 3D models in the field of view of the user.

The user interaction tracking module 414 monitors and processes user interactions with the generated 3D content, such as gestures to manipulate, resize, or rotate the objects.

The co-viewing session management component 416 enables collaborative AR experiences where multiple users can interact with the same virtual content in real-time, even when they are in the same physical location. This component creates a shared AR environment where virtual content is synchronized between users, allowing changes made by one user to be reflected in real-time on other users'devices. It establishes a shared AR space where virtual content is synchronized between users, meaning that when one user moves or interacts with a 3D object, those changes are reflected in real-time for all other users in the session.

The processing and synchronization are handled through a combination of client-side and server-side operations. Most rendering and interaction handling occurs on each user's device, including tracking the user's environment, rendering AR objects, and handling interactions. Synchronization between devices is managed by backend servers, which handle communication between devices, ensuring all users see the same content and that changes are updated in real-time. The server acts as a mediator, relaying state changes and interactions between connected clients.

The implementation involves creating AR content with logic to handle shared states and interactions, utilizing APIs and tools to manage the state of virtual content and ensure consistent updates across devices. Since the experience relies on real-time communication between devices via servers, a stable and fast network connection is important for maintaining a smooth experience, as any lag or delay could affect how quickly changes are reflected between users.

On the server side 420, depicted on the right of FIG. 4, we see the components responsible for processing the user's request and generating the 3D content. The text processing component 422 receives the text from the AR device and prepares it for further processing. For example, the text processing component may extract keywords from the user-spoken instruction, and perform a safety check by checking the words and phrases received, with a list of objectionable words and/or phrases.

The generative language model interface 424 processes the initial prompt using a large language model (LLM) to generate a refined prompt for the image generation model. This interface can operate in different configurations depending on the system architecture and requirements.

In some embodiments, the generative language model may be hosted externally by another service provider. In this case, the prompt writer 426 creates a prompt and then communicates it over a network to the externally hosted LLM. This approach allows for flexibility and scalability, as it can leverage powerful cloud-based language models without the need for local infrastructure.

The LLM used in this process may be fine-tuned for the specific task of generating prompts for image creation. Fine-tuning involves training the model on a dataset relevant to the task, which can improve its performance and make its outputs more suitable for the intended use case. Additionally, the system may include a carefully crafted system prompt that provides context and instructions to the LLM, guiding its behavior and output.

For example, a user prompt might be “Create a purple unicorn with a rainbow mane,” while the system prompt could be more detailed and instructive, such as: “You are an AI assistant specialized in creating detailed, vivid descriptions for image generation. Your task is to take the user's input and expand it into a comprehensive, visually rich prompt that will guide an image generation model. Focus on details like colors, textures, lighting, and composition. Ensure the description is family-friendly and avoid any inappropriate content.”

In alternative embodiments, the LLM may be hosted locally on the server. This configuration can offer advantages in terms of reduced latency and increased control over the model and its outputs. Local hosting may be preferred in scenarios where data privacy is a critical concern or when consistent, low-latency performance is required.

Regardless of the hosting configuration, the generative language model interface 424 works in conjunction with the prompt writer 426 to create specific, detailed instructions for the image generation model. This refined prompt is designed to produce high-quality, relevant 2D representations that can be effectively converted into 3D models in subsequent steps of the pipeline.

The image generation model interface 428 processes the refined prompt to create a 2D representation (e.g., a 2d image) of the requested object. This interface can be implemented in various configurations to suit different system architectures and requirements.

In some embodiments, the image generation model may be hosted remotely by a third-party service provider. In this case, the image generation model interface 428 would communicate the refined prompt over a network to the externally hosted model. This approach allows for flexibility and scalability, as it can leverage powerful cloud-based image generation models without the need for local infrastructure. It also enables easy updates and improvements to the model without requiring changes to the local system.

Alternatively, the image generation model may be hosted locally on the server. This configuration can offer advantages in terms of reduced latency and increased control over the model and its outputs. Local hosting may be preferred in scenarios where data privacy is a critical concern or when consistent, low-latency performance is required.

The image generation model used in this process may be fine-tuned for the specific task of creating 2D representations suitable for 3D model generation. Fine-tuning involves training the model on a dataset relevant to the task, which can improve its performance and make its outputs more suitable for the intended use case. Additionally, the system may include a carefully crafted system prompt that provides context and instructions to the image generation model, guiding its behavior and output.

For example, a system prompt for the image generation model might be: “You are an AI specialized in creating detailed 2D images for 3D model generation. Your task is to take the refined textual description and generate a clear, high-contrast image that emphasizes the object's shape, texture, and key features. Focus on creating images that will be suitable for conversion into 3D models, paying particular attention to depth cues and object boundaries.”

Regardless of the hosting configuration, the image generation model interface 428 works to process the refined prompt and produce a high-quality 2D representation that can be effectively converted into a 3D model in subsequent steps of the pipeline.

The 2D-to-3D conversion pipeline 430 is the 2D image into a detailed 3D model. This pipeline consists of several interconnected components, each performing a specific function in the conversion process.

The segmentation processing component 432 is responsible for isolating the object of interest within the 2D image. This component employs advanced computer vision algorithms to accurately separate the target object from its background and any other elements in the image. For example, if the 2D image contains a unicorn in a forest setting, the segmentation component would isolate just the unicorn figure.

The lifter component 434 takes the segmented 2D representation and transforms it into a low-resolution 3D mesh. This process, often referred to as “2.5D” conversion, involves estimating depth information from the 2D image and creating an initial three-dimensional structure. The lifter component may use techniques such as depth estimation algorithms or neural networks trained on large datasets of 2D images and corresponding 3D models to perform this transformation.

The 2D-to-3D converter model 436 then processes the low-resolution 3D mesh to generate a more refined initial 3D model. This component may employ various techniques such as mesh refinement algorithms, texture mapping, and geometry optimization to enhance the detail and accuracy of the 3D representation. For instance, it might add more polygons to smooth out rough edges or apply more detailed textures based on the original 2D image.

The 3D model refinement component 438 is improved the quality and realism of the initial 3D model. This component employs a series of sophisticated algorithms to enhance various aspects of the model:
Increasing detail: The component may use subdivision surfaces techniques (e.g., Catmull-Clark algorithm) or neural mesh refinement models like MeshCNN to add more geometric complexity and fine details to the model.
Enhancing surface characteristics: Advanced texture synthesis algorithms or AI-powered tools like DeepTexture may be used to improve the model's surface textures, making them more realistic and consistent with the original 2D image.
Refining geometric features: The component may apply techniques such as edge sharpening, normal map generation, or even AI-driven geometric detail transfer to enhance the model's overall shape and features.

For example, in the case of a generated unicorn model, the refinement component might enhance the details of the mane, add realistic fur textures, and refine the shape of the horn to make it more pronounced and magical in appearance.

It is important to note that the entire content generation data processing pipeline can be implemented using a combination of computer vision techniques and modern deep learning approaches. The specific algorithms and models used in each component may vary depending on the implementation and can be updated or replaced as new technologies emerge.

In various embodiments, each component of the pipeline may be implemented via a cloud-based service, locally on a server, or remotely. This flexibility allows for scalability and the ability to leverage specialized hardware or distributed computing resources when needed. Additionally, some of the models used within the pipeline, particularly those involving complex AI algorithms, may be accessed over a network, enabling the system to utilize the most up-to-date and powerful AI technologies for 3D content generation.

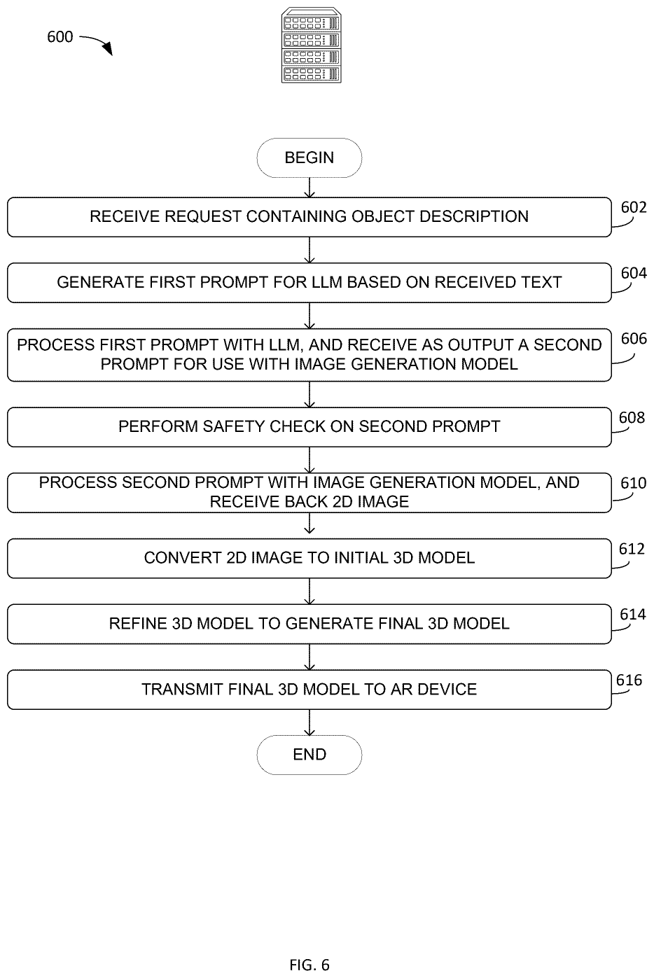

The method illustrated in FIG. 6 outlines the process for generating and displaying a 3D content item in an AR environment based on voice input. The method begins with several operations performed on the AR device side.

First, at operation 502, the AR device detects a spoken command from the user. For example, the user may say “Imagine a purple unicorn” to initiate the content generation process. This operation utilizes the speech-to-text processing component 408 to capture and recognize the voice input.

In operation 504, the AR device performs speech-to-text conversion of the spoken command and processes the resulting text to extract words describing the requested object or content item. This step may involve natural language processing techniques to identify key descriptors and object characteristics from the user's command.

Operation 506 involves performing an initial safety check on the text describing the requested object or content item. This safety check is carried out by the text processing and safety check component 410 and may include parsing the text for predetermined keywords associated with inappropriate content. If potentially problematic content is detected, the request may be blocked or modified at this stage.

In operation 508, the AR device transmits the processed and vetted request to the server for further processing and 3D content generation.

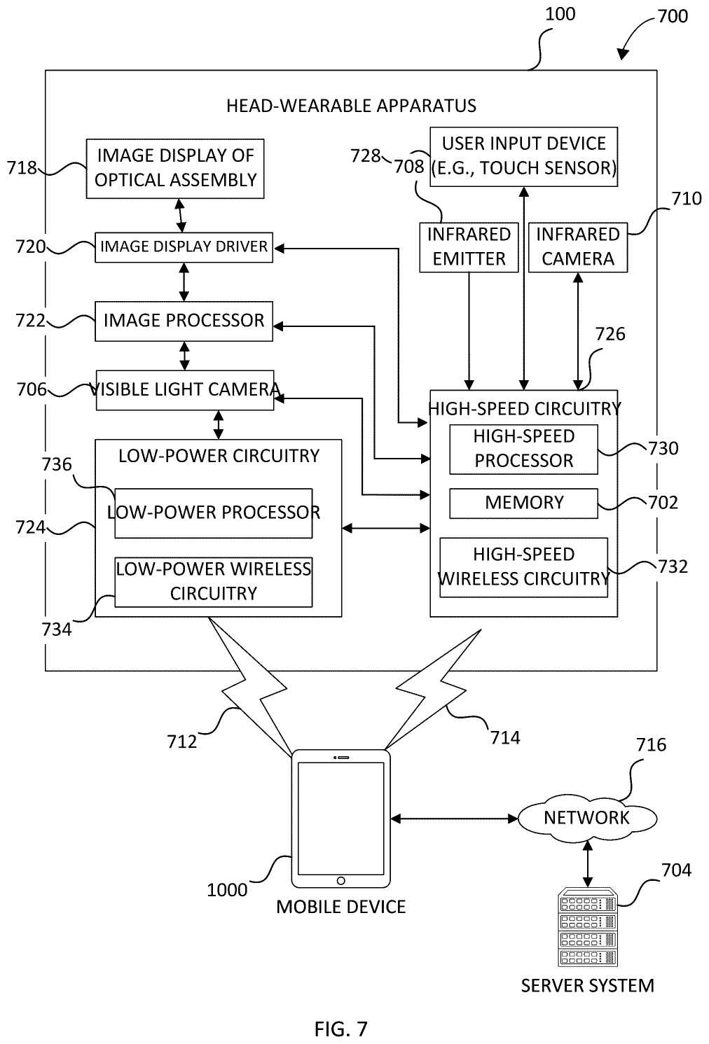

The server operations illustrated in FIG. 7 then commence. At operation 602 the server receives the request containing the object description from the AR device. Next, in operation 604, the system generates a first prompt for the LLM based on the received text. This is performed by the generative language model interface 424 and prompt writer 426.

At operation 606 the first prompt is processed with the LLM, typically a transformer-based model, such as GPT-3.5 or a similar model, and receives as output a second prompt for use with the image generation model. This step refines and expands the initial description to create a more detailed and specific prompt for image generation.

Operation 608 performs a safety check on the second prompt to ensure the refined description does not contain inappropriate content.

In operation 610, the system processes the second prompt with the image generation model, such as Dream Shaper V8, and receives back a 2D image representation of the described object.

Operation 612 converts the 2D image to an initial 3D model using the 2D-to-3D conversion pipeline 430. This involves segmentation, lifting to a low-resolution 3D mesh, and initial 3D model generation.

In operation 614, the system refines the 3D model to generate the final 3D model, improving its quality, detail, and realism.

Finally, operation 616 involves transmitting the final 3D model to the AR device for presentation.

Referring again to the AR device operations in FIG. 6, at operation 512, the AR device receives the 3D model of the requested object or content item from the server.

In operation 514, the AR device presents the 3D model in AR space using the AR display and rendering component 412.

Operation 516 detects and processes a request to initiate a co-viewing session, allowing multiple users to view and interact with the 3D model simultaneously. This is managed by the co-viewing session management component 416.

Operation 518 involves detecting user interactions with the 3D model, such as gestures to manipulate, resize, or reposition the object. This is handled by the user interaction tracking module 414.

Lastly, operation 520 transmits state change data to the server for synchronizing the view across multiple AR devices in a co-viewing session. This ensures all users see the same manipulations and changes to the 3D model in real-time, facilitated by the synchronization service 440 on the server side.

This comprehensive process enables users to generate, view, and collaboratively interact with 3D content in an AR environment using voice commands and natural interactions.

### System with Head-Wearable Apparatus

FIG. 7 illustrates a system 700 including a head-wearable apparatus 116 with a selector input device, according to some examples. FIG. 7 is a high-level functional block diagram of an example head-wearable apparatus 116 communicatively coupled to a mobile device 114 and various server systems 704 (e.g., the server system 110) via various networks 108.

The head-wearable apparatus 116 includes one or more cameras, each of which may be, for example, a visible light camera 706, an infrared emitter 708, and an infrared camera 710.

The mobile device 114 connects with head-wearable apparatus 116 using both a low-power wireless connection 712 and a high-speed wireless connection 714. The mobile device 114 is also connected to the server system 704 and the network 716.

The head-wearable apparatus 116 further includes two image displays of the image display of optical assembly 718. The two image displays of optical assembly 718 include one associated with the left lateral side and one associated with the right lateral side of the head-wearable apparatus 116. The head-wearable apparatus 116 also includes an image display driver 720, an image processor 722, low-power circuitry 724, and high-speed circuitry 726. The image display of optical assembly 718 is for presenting images and videos, including an image that can include a graphical user interface to a user of the head-wearable apparatus 116.

The image display driver 720 commands and controls the image display of optical assembly 718. The image display driver 720 may deliver image data directly to the image display of optical assembly 718 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 728 (e.g., touch sensor or push button), including an input surface on the head-wearable apparatus 116. The user input device 728 (e.g., touch sensor or push button) is to receive from the user an input selection to manipulate the graphical user interface of the presented image.

The components shown in FIG. 7 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 706 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 702, which stores instructions to perform a subset, or all the functions described herein. The memory 702 can also include storage device.

As shown in FIG. 7, the high-speed circuitry 726 includes a high-speed processor 730, a memory 702, and high-speed wireless circuitry 732. In some examples, the image display driver 720 is coupled to the high-speed circuitry 726 and operated by the high-speed processor 730 to drive the left and right image displays of the image display of optical assembly 718. The high-speed processor 730 may be any processor capable of managing high-speed communications and operation of any general computing system needed for the head-wearable apparatus 116. The high-speed processor 730 includes processing resources needed for managing high-speed data transfers on a high-speed wireless connection 714 to a wireless local area network (WLAN) using the high-speed wireless circuitry 732. In certain examples, the high-speed processor 730 executes an operating system such as a LINUX operating system or other such operating system of the head-wearable apparatus 116, and the operating system is stored in the memory 702 for execution. In addition to any other responsibilities, the high-speed processor 730 executing a software architecture for the head-wearable apparatus 116 is used to manage data transfers with high-speed wireless circuitry 732. In certain examples, the high-speed wireless circuitry 732 is configured to implement Institute of Electrical and Electronic Engineers (IEEE) 802.11 communication standards, also referred to herein as WI-FI®. In some examples, other high-speed communications standards may be implemented by the high-speed wireless circuitry 732.

The low-power wireless circuitry 734 and the high-speed wireless circuitry 732 of the head-wearable apparatus 116 can include short-range transceivers (e.g., Bluetooth™, Bluetooth LE, Zigbee, ANT+) and wireless wide, local, or wide area network transceivers (e.g., cellular or WI-FI®). Mobile device 114, including the transceivers communicating via the low-power wireless connection 712 and the high-speed wireless connection 714, may be implemented using details of the architecture of the head-wearable apparatus 116, as can other elements of the network 716.

The memory 702 includes any storage device capable of storing various data and applications, including, among other things, camera data generated by the left and right visible light cameras 706, the infrared camera 710, and the image processor 722, as well as images generated for display by the image display driver 720 on the image displays of the image display of optical assembly 718. While the memory 702 is shown as integrated with high-speed circuitry 726, in some examples, the memory 702 may be an independent standalone element of the head-wearable apparatus 116. In certain such examples, electrical routing lines may provide a connection through a chip that includes the high-speed processor 730 from the image processor 722 or the low-power processor 736 to the memory 702. In some examples, the high-speed processor 730 may manage addressing of the memory 702 such that the low-power processor 736 will boot the high-speed processor 730 any time that a read or write operation involving memory 702 is needed.

As shown in FIG. 7, the low-power processor 736 or high-speed processor 730 of the head-wearable apparatus 116 can be coupled to the camera (visible light camera 706, infrared emitter 708, or infrared camera 710), the image display driver 720, the user input device 728 (e.g., touch sensor or push button), and the memory 702.

The head-wearable apparatus 116 is connected to a host computer. For example, the head-wearable apparatus 116 is paired with the mobile device 114 via the high-speed wireless connection 714 or connected to the server system 704 via the network 716. The server system 704 may be one or more computing devices as part of a service or network computing system, for example, that includes a processor, a memory, and network communication interface to communicate over the network 716 with the mobile device 114 and the head-wearable apparatus 116.

The mobile device 114 includes a processor and a network communication interface coupled to the processor. The network communication interface allows for communication over the network 716, low-power wireless connection 712, or high-speed wireless connection 714. Mobile device 114 can further store at least portions of the instructions in the memory of the mobile device 114 memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 720. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 704, such as the user input device 728, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include sensors and display elements integrated with the head-wearable apparatus 116. For example, peripheral device elements may include any I/O components including output components, motion components, position components, or any other such elements described herein.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 712 and high-speed wireless connection 714 from the mobile device 114 via the low-power wireless circuitry 734 or high-speed wireless circuitry 732.

### Machine Architecture

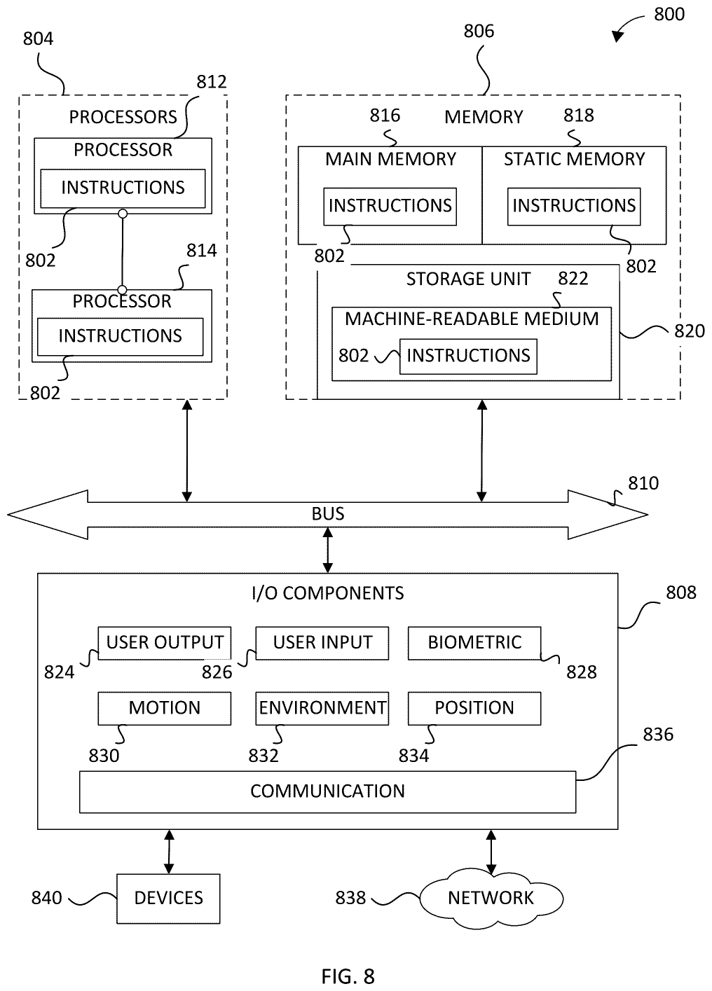

FIG. 8 is a diagrammatic representation of the machine 800 within which instructions 802 (e.g., software, a program, an application, an applet, an app, or other executable code) for causing the machine 800 to perform any one or more of the methodologies discussed herein may be executed. For example, the instructions 802 may cause the machine 800 to execute any one or more of the methods described herein. The instructions 802 transform the general, non-programmed machine 800 into a particular machine 800 programmed to carry out the described and illustrated functions in the manner described. The machine 800 may operate as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 802, sequentially or otherwise, that specify actions to be taken by the machine 800. Further, while a single machine 800 is illustrated, the term “machine” shall also be taken to include a collection of machines that individually or jointly execute the instructions 802 to perform any one or more of the methodologies discussed herein. The machine 800, for example, may comprise the user system 102 or any one of multiple server devices forming part of the server system 110. In some examples, the machine 800 may also comprise both client and server systems, with certain operations of a particular method or algorithm being performed on the server-side and with certain operations of the method or algorithm being performed on the client-side.

The machine 800 may include processors 804, memory 806, and input/output I/O components 808, which may be configured to communicate with each other via a bus 810.

The memory 806 includes a main memory 816, a static memory 818, and a storage unit 820, both accessible to the processors 804 via the bus 810. The main memory 806, the static memory 818, and storage unit 820 store the instructions 802 embodying any one or more of the methodologies or functions described herein. The instructions 802 may also reside, completely or partially, within the main memory 816, within the static memory 818, within machine-readable medium 822 within the storage unit 820, within at least one of the processors 804 (e.g., within the processor's cache memory), or any suitable combination thereof, during execution thereof by the machine 800.

The I/O components 808 may include a wide variety of components to receive input, provide output, produce output, transmit information, exchange information, capture measurements, and so on. The specific I/O components 808 that are included in a particular machine will depend on the type of machine. For example, portable machines such as mobile phones may include a touch input device or other such input mechanisms, while a headless server machine will likely not include such a touch input device. It will be appreciated that the I/O components 808 may include many other components that are not shown in FIG. 8. In various examples, the I/O components 808 may include user output components 824 and user input components 826. The user output components 824 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 826 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

The motion components 830 include acceleration sensor components (e.g., accelerometer), gravitation sensor components, rotation sensor components (e.g., gyroscope).

The environmental components 832 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 808 further include communication components 836 operable to couple the machine 800 to a network 838 or devices 840 via respective coupling or connections. For example, the communication components 836 may include a network interface component or another suitable device to interface with the network 838. In further examples, the communication components 836 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 840 may be another machine or any of a wide variety of peripheral devices (e.g., a peripheral device coupled via a USB).

Moreover, the communication components 836 may detect identifiers or include components operable to detect identifiers. For example, the communication components 836 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 836, such as location via Internet Protocol (IP) geolocation, location via Wi-Fi® signal triangulation, location via detecting an NFC beacon signal that may indicate a particular location, and so forth.

The various memories (e.g., main memory 816, static memory 818, and memory of the processors 804) and storage unit 820 may store one or more sets of instructions and data structures (e.g., software) embodying or used by any one or more of the methodologies or functions described herein. These instructions (e.g., the instructions 802), when executed by processors 804, cause various operations to implement the disclosed examples.

The instructions 802 may be transmitted or received over the network 838, using a transmission medium, via a network interface device (e.g., a network interface component included in the communication components 836) and using any one of several well-known transfer protocols (e.g., hypertext transfer protocol (HTTP)). Similarly, the instructions 802 may be transmitted or received using a transmission medium via a coupling (e.g., a peer-to-peer coupling) to the devices 840.

### Software Architecture

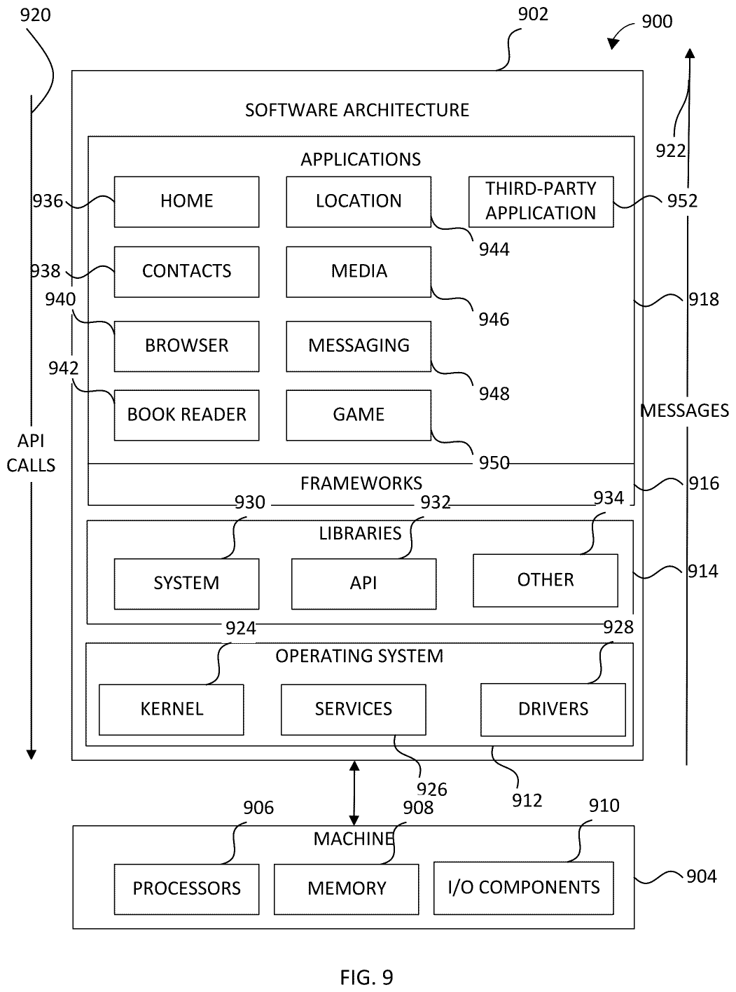

FIG. 9 is a block diagram 900 illustrating a software architecture 902, which can be installed on any one or more of the devices described herein. The software architecture 902 is supported by hardware such as a machine 904 that includes processors 906, memory 908, and I/O components 910. In this example, the software architecture 902 can be conceptualized as a stack of layers, where each layer provides a particular functionality. The software architecture 902 includes layers such as an operating system 912, libraries 914, frameworks 916, and applications 918. Operationally, the applications 918 invoke API calls 920 through the software stack and receive messages 922 in response to the API calls 920.

The operating system 912 manages hardware resources and provides common services. The operating system 912 includes, for example, a kernel 924, services 926, and drivers 928. The kernel 924 acts as an abstraction layer between the hardware and the other software layers. For example, the kernel 924 provides memory management, processor management (e.g., scheduling), component management, networking, and security settings, among other functionalities. The services 926 can provide other common services for the other software layers. The drivers 928 are responsible for controlling or interfacing with the underlying hardware. For instance, the drivers 928 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 914 provide a common low-level infrastructure used by the applications 918. The libraries 914 can include system libraries 930 (e.g., C standard library) that provide functions such as memory allocation functions, string manipulation functions, mathematical functions, and the like. In addition, the libraries 914 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 914 can also include a wide variety of other libraries 934 to provide many other APIs to the applications 918.

The frameworks 916 provide a common high-level infrastructure that is used by the applications 918. For example, the frameworks 916 provide various graphical user interface (GUI) functions, high-level resource management, and high-level location services. The frameworks 916 can provide a broad spectrum of other APIs that can be used by the applications 918, some of which may be specific to a particular operating system or platform.

In an example, the applications 918 may include a home application 936, a contacts application 938, a browser application 940, a book reader application 942, a location application 944, a media application 946, a messaging application 948, a game application 950, and a broad assortment of other applications such as a third-party application 952. The applications 918 are programs that execute functions defined in the programs. Various programming languages can be employed to create one or more of the applications 918, structured in a variety of manners, such as object-oriented programming languages (e.g., Objective-C, Java, or C++) or procedural programming languages (e.g., C or assembly language). In a specific example, the third-party application 952 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 952 can invoke the API calls 920 provided by the operating system 912 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLES

Example 1 is a server for generating a three-dimensional (3D) content item for viewing via an augmented reality (AR) device, the server comprising: at least one processor; at least one memory storage device storing instructions thereon, which, when processed by the at least one processor, cause the server to perform operations comprising: receive, over a network connection, text obtained through speech-to-text conversion of an audible statement detected at the AR device; generating a first prompt based on the received text, the first prompt configured to instruct a generative language model to generate a second prompt for use as input with an image generation model, the second prompt configured to instruct the image generation model to generate a two-dimensional (2D) representation of an object indicated by the text; processing the first prompt, as input, to the generative language model, and receiving, as output, the second prompt; processing the second prompt, as input, to the image generation model, and receiving, over a network, the 2D representation of the object indicated by the text; converting the 2D representation of the object into an initial 3D model representing the object using a 2D-to-3D conversion model; processing the initial 3D model of the object to generate a final 3D model of the object; and transmitting the final 3D model of the object over a network to the AR device for presentation in 3D space by the AR device.

In Example 2, the subject matter of Example 1 includes, D model comprises: segmenting the 2D representation to isolate the object; applying a lifter algorithm to transform the segmented 2D representation into a low-resolution 3D mesh; and processing the low-resolution 3D mesh with the 2D-to-3D conversion model to generate as output the initial 3D model of the object.

In Example 3, the subject matter of Example 2 includes, D model of the object comprises one or more of the following: increasing a level of detail of the initial 3D model; applying enhanced surface characteristics to the initial 3D model; and refining geometric features of the initial 3D model to create the final 3D model.

In Example 4, the subject matter of Examples 1-3 includes, wherein the operations further comprise: performing a safety check on the first prompt prior to transmitting the first prompt to the generative language model, wherein the safety check comprises: parsing the first prompt for predetermined keywords associated with inappropriate content; if a predetermined keyword is detected, blocking the first prompt from being transmitted to the generative language model.

In Example 5, the subject matter of Examples 1-4 includes, wherein the operations further comprise: performing a safety check on the second prompt received from the generative language model prior to transmitting the second prompt to the image generation model, wherein the safety check comprises: parsing the second prompt for predetermined keywords associated with inappropriate content; if a predetermined keyword is detected, blocking the second prompt from being transmitted to the image generation model; if no predetermined keywords are detected, moderating the second prompt against a predefined context list to determine appropriateness of the content.

In Example 6, the subject matter of Examples 1-5 includes, wherein the operations further comprise: establishing a co-viewing session between the AR device and a second AR device, wherein the co-viewing session utilizes a synchronization service to perform synchronization operations comprising: receiving, from the AR device, state change data impacting the presentation of the final 3D model, wherein the state change data are generated as a result of a user performing hand gestures to manipulate the final 3D model in 3D space; processing the received state change data to generate synchronized state data; communicating the synchronized state data to the second AR device; wherein the synchronized state data enables the second AR device to display the final 3D model with the manipulations applied, thereby providing a synchronized view of the final 3D model to a user of the second AR device.

In Example 7, the subject matter of Example 6 includes, wherein the synchronization operations further comprise: receiving, from the second AR device, additional state change data impacting the presentation of the final 3D model, wherein the additional state change data are generated as a result of a user of the second AR device performing hand gestures to manipulate the final 3D model in 3D space; processing the received additional state change data to generate revised synchronized state data; communicating the revised synchronized state data to the AR device; wherein the revised synchronized state data enables the AR device to update its display of the final 3D model with the manipulations applied by the user of the second AR device, thereby maintaining a synchronized view of the final 3D model across both the AR device and the second AR device.

Example 8 is a method for generating a three-dimensional (3D) content item for viewing via an augmented reality (AR) device, the method comprising: receiving, over a network connection, text obtained through speech-to-text conversion of an audible statement detected at the AR device; generating a first prompt based on the received text, the first prompt configured to instruct a generative language model to generate a second prompt for use as input with an image generation model, the second prompt configured to instruct the image generation model to generate a two-dimensional (2D) representation of an object indicated by the text; processing the first prompt, as input, to the generative language model, and receiving, as output, the second prompt; processing the second prompt, as input, to the image generation model, and receiving, over a network, the 2D representation of the object indicated by the text; converting the 2D representation of the object into an initial 3D model representing the object using a 2D-to-3D conversion model; processing the initial 3D model of the object to generate a final 3D model of the object; and transmitting the final 3D model of the object over a network to the AR device for presentation in 3D space by the AR device.

In Example 9, the subject matter of Example 8 includes, D model comprises: segmenting the 2D representation to isolate the object; applying a lifter algorithm to transform the segmented 2D representation into a low-resolution 3D mesh; and processing the low-resolution 3D mesh with the 2D-to-3D conversion model to generate as output the initial 3D model of the object.

In Example 10, the subject matter of Example 9 includes, D model of the object comprises one or more of the following: increasing a level of detail of the initial 3D model; applying enhanced surface characteristics to the initial 3D model; and refining geometric features of the initial 3D model to create the final 3D model.

In Example 11, the subject matter of Examples 8-10 includes, performing a safety check on the first prompt prior to transmitting the first prompt to the generative language model, wherein the safety check comprises: parsing the first prompt for predetermined keywords associated with inappropriate content; if a predetermined keyword is detected, blocking the first prompt from being transmitted to the generative language model.

In Example 12, the subject matter of Examples 8-11 includes, performing a safety check on the second prompt received from the generative language model prior to transmitting the second prompt to the image generation model, wherein the safety check comprises: parsing the second prompt for predetermined keywords associated with inappropriate content; if a predetermined keyword is detected, blocking the second prompt from being transmitted to the image generation model; if no predetermined keywords are detected, moderating the second prompt against a predefined context list to determine appropriateness of the content.

In Example 13, the subject matter of Examples 8-12 includes, establishing a co-viewing session between the AR device and a second AR device, wherein the co-viewing session utilizes a synchronization service to perform synchronization operations comprising: receiving, from the AR device, state change data impacting the presentation of the final 3D model, wherein the state change data are generated as a result of a user performing hand gestures to manipulate the final 3D model in 3D space; processing the received state change data to generate synchronized state data; communicating the synchronized state data to the second AR device; wherein the synchronized state data enables the second AR device to display the final 3D model with the manipulations applied, thereby providing a synchronized view of the final 3D model to a user of the second AR device.

In Example 14, the subject matter of Example 13 includes, wherein the synchronization operations further comprise: receiving, from the second AR device, additional state change data impacting the presentation of the final 3D model, wherein the additional state change data are generated as a result of a user of the second AR device performing hand gestures to manipulate the final 3D model in 3D space; processing the received additional state change data to generate revised synchronized state data; communicating the revised synchronized state data to the AR device; wherein the revised synchronized state data enables the AR device to update its display of the final 3D model with the manipulations applied by the user of the second AR device, thereby maintaining a synchronized view of the final 3D model across both the AR device and the second AR device.

Example 15 is a system for generating a three-dimensional (3D) content item for viewing via an augmented reality (AR) device, the system comprising: means for receiving, over a network connection, text obtained through speech-to-text conversion of an audible statement detected at the AR device; means for generating a first prompt based on the received text, the first prompt configured to instruct a generative language model to generate a second prompt for use as input with an image generation model, the second prompt configured to instruct the image generation model to generate a two-dimensional (2D) representation of an object indicated by the text; means for processing the first prompt, as input, to the generative language model, and receiving, as output, the second prompt; means for processing the second prompt, as input, to the image generation model, and receiving, over a network, the 2D representation of the object indicated by the text; means for converting the 2D representation of the object into an initial 3D model representing the object using a 2D-to-3D conversion model; means for processing the initial 3D model of the object to generate a final 3D model of the object; and means for transmitting the final 3D model of the object over a network to the AR device for presentation in 3D space by the AR device.

In Example 16, the subject matter of Example 15 includes, D model comprises: means for segmenting the 2D representation to isolate the object; means for applying a lifter algorithm to transform the segmented 2D representation into a low-resolution 3D mesh; and means for processing the low-resolution 3D mesh with the 2D-to-3D conversion model to generate as output the initial 3D model of the object.

In Example 17, the subject matter of Example 16 includes, D model of the object comprises one or more of the following: means for increasing a level of detail of the initial 3D model; means for applying enhanced surface characteristics to the initial 3D model; and means for refining geometric features of the initial 3D model to create the final 3D model.

In Example 18, the subject matter of Examples 15-17 includes, means for performing a safety check on the first prompt prior to transmitting the first prompt to the generative language model, wherein the safety check comprises: means for parsing the first prompt for predetermined keywords associated with inappropriate content; means for blocking the first prompt from being transmitted to the generative language model if a predetermined keyword is detected.

In Example 19, the subject matter of Examples 15-18 includes, means for performing a safety check on the second prompt received from the generative language model prior to transmitting the second prompt to the image generation model, wherein the safety check comprises: means for parsing the second prompt for predetermined keywords associated with inappropriate content; means for blocking the second prompt from being transmitted to the image generation model if a predetermined keyword is detected; means for moderating the second prompt against a predefined context list to determine appropriateness of the content if no predetermined keywords are detected.

In Example 20, the subject matter of Examples 15-19 includes, means for establishing a co-viewing session between the AR device and a second AR device, wherein the co-viewing session utilizes a synchronization service to perform synchronization operations comprising: means for receiving, from the AR device, state change data impacting the presentation of the final 3D model, wherein the state change data are generated as a result of a user performing hand gestures to manipulate the final 3D model in 3D space; means for processing the received state change data to generate synchronized state data; means for communicating the synchronized state data to the second AR device; wherein the synchronized state data enables the second AR device to display the final 3D model with the manipulations applied, thereby providing a synchronized view of the final 3D model to a user of the second AR device.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components, also referred to as “computer-implemented.” Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium”mean the same thing and may be used interchangeably in this disclosure.

“User device” refers, for example, to a device accessed, controlled or owned by a user and with which the user interacts perform an action or interaction on the user device, including an interaction with other users or computer systems.

What is claimed is:

1. A server for generating a three-dimensional (3D) content item for viewing via an augmented reality (AR) device, the server comprising:
at least one processor;
at least one memory storage device storing instructions thereon, which, when processed by the at least one processor, cause the server to perform operations comprising:
receive, over a network connection, text obtained through speech-to-text conversion of an audible statement detected at the AR device;
generating a first prompt based on the received text, the first prompt configured to instruct a generative language model to generate a second prompt for use as input with an image generation model, the second prompt configured to instruct the image generation model to generate a two-dimensional (2D) representation of an object indicated by the text;
processing the first prompt, as input, to the generative language model, and receiving, as output, the second prompt;
processing the second prompt, as input, to the image generation model, and receiving, over a network, the 2D representation of the object indicated by the text;
converting the 2D representation of the object into an initial 3D model representing the object using a 2D-to-3D conversion model;
processing the initial 3D model of the object to generate a final 3D model of the object; and
transmitting the final 3D model of the object over a network to the AR device for presentation in 3D space by the AR device.

2. The server of claim 1, wherein converting the 2D representation of the object into an initial 3D model comprises:
segmenting the 2D representation to isolate the object;
applying a lifter algorithm to transform the segmented 2D representation into a low-resolution 3D mesh; and
processing the low-resolution 3D mesh with the 2D-to-3D conversion model to generate as output the initial 3D model of the object.

3. The server of claim 2, wherein processing the initial 3D model of the object to generate a final 3D model of the object comprises one or more of the following:
increasing a level of detail of the initial 3D model;
applying enhanced surface characteristics to the initial 3D model; and
refining geometric features of the initial 3D model to create the final 3D model.

4. The server of claim 1, wherein the operations further comprise:
performing a safety check on the first prompt prior to transmitting the first prompt to the generative language model, wherein the safety check comprises:
parsing the first prompt for predetermined keywords associated with inappropriate content;
if a predetermined keyword is detected, blocking the first prompt from being transmitted to the generative language model.

5. The server of claim 1, wherein the operations further comprise:
performing a safety check on the second prompt received from the generative language model prior to transmitting the second prompt to the image generation model, wherein the safety check comprises:
parsing the second prompt for predetermined keywords associated with inappropriate content;
if a predetermined keyword is detected, blocking the second prompt from being transmitted to the image generation model;
if no predetermined keywords are detected, moderating the second prompt against a predefined context list to determine appropriateness of the content.

6. The server of claim 1, wherein the operations further comprise:
establishing a co-viewing session between the AR device and a second AR device, wherein the co-viewing session utilizes a synchronization service to perform synchronization operations comprising:
receiving, from the AR device, state change data impacting the presentation of the final 3D model, wherein the state change data are generated as a result of a user performing hand gestures to manipulate the final 3D model in 3D space;
processing the received state change data to generate synchronized state data;
communicating the synchronized state data to the second AR device;
wherein the synchronized state data enables the second AR device to display the final 3D model with the manipulations applied, thereby providing a synchronized view of the final 3D model to a user of the second AR device.

7. The server of claim 6, wherein the synchronization operations further comprise:
receiving, from the second AR device, additional state change data impacting the presentation of the final 3D model, wherein the additional state change data are generated as a result of a user of the second AR device performing hand gestures to manipulate the final 3D model in 3D space;
processing the received additional state change data to generate revised synchronized state data;
communicating the revised synchronized state data to the AR device;
wherein the revised synchronized state data enables the AR device to update its display of the final 3D model with the manipulations applied by the user of the second AR device, thereby maintaining a synchronized view of the final 3D model across both the AR device and the second AR device.

8. A method for generating a three-dimensional (3D) content item for viewing via an augmented reality (AR) device, the method comprising:
receiving, over a network connection, text obtained through speech-to-text conversion of an audible statement detected at the AR device;
generating a first prompt based on the received text, the first prompt configured to instruct a generative language model to generate a second prompt for use as input with an image generation model, the second prompt configured to instruct the image generation model to generate a two-dimensional (2D) representation of an object indicated by the text;
processing the first prompt, as input, to the generative language model, and receiving, as output, the second prompt;
processing the second prompt, as input, to the image generation model, and receiving, over a network, the 2D representation of the object indicated by the text;
converting the 2D representation of the object into an initial 3D model representing the object using a 2D-to-3D conversion model;
processing the initial 3D model of the object to generate a final 3D model of the object; and
transmitting the final 3D model of the object over a network to the AR device for presentation in 3D space by the AR device.

9. The method of claim 8, wherein converting the 2D representation of the object into an initial 3D model comprises:
segmenting the 2D representation to isolate the object;
applying a lifter algorithm to transform the segmented 2D representation into a low-resolution 3D mesh; and
processing the low-resolution 3D mesh with the 2D-to-3D conversion model to generate as output the initial 3D model of the object.

10. The method of claim 9, wherein processing the initial 3D model of the object to generate a final 3D model of the object comprises one or more of the following:
increasing a level of detail of the initial 3D model;
applying enhanced surface characteristics to the initial 3D model; and
refining geometric features of the initial 3D model to create the final 3D model.

11. The method of claim 8, further comprising:
performing a safety check on the first prompt prior to transmitting the first prompt to the generative language model, wherein the safety check comprises:
parsing the first prompt for predetermined keywords associated with inappropriate content;
if a predetermined keyword is detected, blocking the first prompt from being transmitted to the generative language model.

12. The method of claim 8, further comprising:
performing a safety check on the second prompt received from the generative language model prior to transmitting the second prompt to the image generation model, wherein the safety check comprises:
parsing the second prompt for predetermined keywords associated with inappropriate content;
if a predetermined keyword is detected, blocking the second prompt from being transmitted to the image generation model;
if no predetermined keywords are detected, moderating the second prompt against a predefined context list to determine appropriateness of the content.

13. The method of claim 8, further comprising:
establishing a co-viewing session between the AR device and a second AR device, wherein the co-viewing session utilizes a synchronization service to perform synchronization operations comprising:
receiving, from the AR device, state change data impacting the presentation of the final 3D model, wherein the state change data are generated as a result of a user performing hand gestures to manipulate the final 3D model in 3D space;
processing the received state change data to generate synchronized state data; communicating the synchronized state data to the second AR device;
wherein the synchronized state data enables the second AR device to display the final 3D model with the manipulations applied, thereby providing a synchronized view of the final 3D model to a user of the second AR device.

14. The method of claim 13, wherein the synchronization operations further comprise:
receiving, from the second AR device, additional state change data impacting the presentation of the final 3D model, wherein the additional state change data are generated as a result of a user of the second AR device performing hand gestures to manipulate the final 3D model in 3D space;
processing the received additional state change data to generate revised synchronized state data;
communicating the revised synchronized state data to the AR device;
wherein the revised synchronized state data enables the AR device to update its display of the final 3D model with the manipulations applied by the user of the second AR device, thereby maintaining a synchronized view of the final 3D model across both the AR device and the second AR device.

15. A system for generating a three-dimensional (3D) content item for viewing via an augmented reality (AR) device, the system comprising:
means for receiving, over a network connection, text obtained through speech-to-text conversion of an audible statement detected at the AR device;
means for generating a first prompt based on the received text, the first prompt configured to instruct a generative language model to generate a second prompt for use as input with an image generation model, the second prompt configured to instruct the image generation model to generate a two-dimensional (2D) representation of an object indicated by the text;
means for processing the first prompt, as input, to the generative language model, and receiving, as output, the second prompt;
means for processing the second prompt, as input, to the image generation model, and receiving, over a network, the 2D representation of the object indicated by the text;
means for converting the 2D representation of the object into an initial 3D model representing the object using a 2D-to-3D conversion model;
means for processing the initial 3D model of the object to generate a final 3D model of the object; and
means for transmitting the final 3D model of the object over a network to the AR device for presentation in 3D space by the AR device.

16. The system of claim 15, wherein the means for converting the 2D representation of the object into an initial 3D model comprises:
means for segmenting the 2D representation to isolate the object;
means for applying a lifter algorithm to transform the segmented 2D representation into a low-resolution 3D mesh; and
means for processing the low-resolution 3D mesh with the 2D-to-3D conversion model to generate as output the initial 3D model of the object.

17. The system of claim 16, wherein the means for processing the initial 3D model of the object to generate a final 3D model of the object comprises one or more of the following:
means for increasing a level of detail of the initial 3D model;
means for applying enhanced surface characteristics to the initial 3D model; and
means for refining geometric features of the initial 3D model to create the final 3D model.

18. The system of claim 15, further comprising:
means for performing a safety check on the first prompt prior to transmitting the first prompt to the generative language model, wherein the safety check comprises:
means for parsing the first prompt for predetermined keywords associated with inappropriate content;
means for blocking the first prompt from being transmitted to the generative language model if a predetermined keyword is detected.

19. The system of claim 15, further comprising:
means for performing a safety check on the second prompt received from the generative language model prior to transmitting the second prompt to the image generation model, wherein the safety check comprises:
means for parsing the second prompt for predetermined keywords associated with inappropriate content;
means for blocking the second prompt from being transmitted to the image generation model if a predetermined keyword is detected;
means for moderating the second prompt against a predefined context list to determine appropriateness of the content if no predetermined keywords are detected.

20. The system of claim 15, further comprising:
means for establishing a co-viewing session between the AR device and a second AR device, wherein the co-viewing session utilizes a synchronization service to perform synchronization operations comprising:
means for receiving, from the AR device, state change data impacting the presentation of the final 3D model, wherein the state change data are generated as a result of a user performing hand gestures to manipulate the final 3D model in 3D space;
means for processing the received state change data to generate synchronized state data;
means for communicating the synchronized state data to the second AR device;
wherein the synchronized state data enables the second AR device to display the final 3D model with the manipulations applied, thereby providing a synchronized view of the final 3D model to a user of the second AR device.
